(19) United States
(12) Patent Application Publication
(10) Pub. No.: US 2026/0032513 A1
(43) Pub. Date: Jan. 29, 2026

(54) METHODS AND SYSTEMS FOR LOAD BALANCING

(71) Applicant: Comcast Cable Communications, LLC, Philadelphia, PA (US)

(72) Inventors: De Fu LI, Nashua, NH (US); Belal HAMZEH, Westminster, CO (US); Jingjie ZHU, Erie, CO (US)

(21) Appl. No.: 19/281,142

(22) Filed: Jul. 25, 2025

Related U.S. Application Data
(60) Provisional application No. 63/675,550, filed on Jul. 25, 2024.

(51) Int. Cl. H04W 28/082; H04W 28/08

(52) U.S. Cl. CPC H04W 28/082; H04W 28/0983

(57) ABSTRACT

Methods, devices, and systems for load balancing of radio frequency channels are described herein. A load balancer may receive utilization data for radio frequency channels. The utilization data may span an extended period of time, such as several hours or days. The load balancer may apply multiple filters to the utilization data, where each filter may identify subsets of data that may indicate a load imbalance across the radio frequency channels. The load balancer may select subsets of data that satisfy multiple filters, which may be used for determining a resource allocation for the radio frequency channels. The selection of data satisfying multiple filters, and across a longer period of time, may provide for a more accurate identification of load balance across the radio frequency channels.

### CROSS REFERENCE TO RELATED APPLICATIONS

This application claims priority to and the benefit of U.S. Provisional Application No. 63/675,550, filed Jul. 25, 2024, the disclosure of which is hereby incorporated by reference in its entirety.

### BACKGROUND

Radio frequency communication systems, such as cable modem termination systems (CMTS), may provide data communications between premises and external networks. The system may transmit and receive data via radio frequency channels, which may carry data such as video content, voice services, Internet services, etc. Further, the system may include a load balancer, which may allocate radio frequency resources to different computing devices (e.g., cable modems (CMs)) sharing the radio frequency channels. However, load balancers may be limited in their processing capabilities. These limitations may affect how load balancers identify load imbalances in the communication system, which may lead to inefficient resource allocation. These and other shortcomings are addressed by the present disclosure.

### SUMMARY

The following summary is for example purposes only, and is not intended to limit or constrain the detailed description.

Methods, devices, and systems for load balancing for radio frequency channels are described herein. A load balancer may receive utilization rate data for a group of computing devices sharing radio frequency channels, which may correspond to utilization rates of the radio frequency channels over a time period. The load balancer may filter the utilization rate data according to different utilization rate metrics, such that the load balancer identifies different data subsets of the utilization rate data for each of the filters. The load balancer may select subsets of the utilization rate data that satisfy the different filters, for example, where a data subset identified according to one filter overlaps in time with a data subset identified by another filter. The selected utilization rate data subsets may undergo further processing by the load balancer to determine a reallocation of radio frequency resources of the radio frequency channels. This may facilitate a more accurate load balance determination, and may more efficiently utilize processing resources of the load balancer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

These and other features, aspects, and advantages of the present disclosure will become better understood with regard to the following description, claims, and drawings. The present disclosure is presented by way of example, and not limited by, the accompanying drawings in which like numerals indicate similar elements.

FIG. 1 shows an example communication network.

FIG. 2 shows a utilization distribution.

FIG. 3 shows a utilization distribution.

FIG. 4 shows a utilization distribution.

FIG. 5 shows a utilization distribution.

FIG. 6 shows a utilization distribution.

FIG. 7 shows a utilization distribution.

FIG. 8 shows a utilization distribution.

FIG. 9 shows a utilization distribution.

FIG. 10 shows a utilization distribution.

FIG. 11 shows a utilization distribution.

FIG. 12 shows a utilization distribution.

FIG. 13 shows a utilization distribution.

FIG. 14 shows a utilization distribution.

FIG. 15 shows a utilization distribution.

FIG. 16 shows a utilization distribution.

FIG. 17 shows a utilization distribution.

FIG. 18 shows a utilization distribution.

FIG. 19 shows example key performance indicator (KPI) metrics.

FIG. 20 shows frequency resource allocations.

FIG. 21 shows frequency resource allocations.

FIG. 22 shows frequency resource allocations.

FIG. 23 shows frequency resource allocations.

FIG. 24 shows frequency resource allocations.

FIG. 25 shows frequency resource allocations.

FIG. 26 shows frequency resource allocations.

FIG. 27 shows frequency resource allocations.

FIG. 28 shows frequency resource allocations.

FIG. 29 shows a computing device.

FIG. 30 shows a process.

### DETAILED DESCRIPTION OF ILLUSTRATIVE EMBODIMENTS

Methods, devices, and systems for load balancing are described herein. A load balancer may allocate and reallocate radio frequency resources across a number of computing devices sharing the radio frequency spectrum. However, load balancers may be limited in processing capabilities, which may impact the efficiencies in identifying a load imbalance. For example, a load balancer residing on a cable modem termination system (CMTS) server may analyze utilization metrics of the CMs across a short period of time, such as within a 5-minute time period. The load balancer may determine a load imbalance from the utilization metrics and may reallocate radio frequency resources accordingly. However, as utilization metrics that the load balancer analyzes are of a relatively small timeframe, load balancers may be prone to overreact to short fluctuations or spikes in utilization rates, and may unnecessarily reallocate radio frequency resources across the CMs.

According to the present disclosure, a load balancer may be located in a cloud service, which may provide greater processing capabilities and which may facilitate the implementation of more accurate load balancing determinations. A load balancer may receive per-channel utilization data for corresponding computing devices (e.g., CMs) that are sharing radio frequency resources. The utilization data may span an extended period of time, such as several hours or days. The load balancer may apply multiple filters to the utilization data, where each filter may identify subsets of data that may indicate a load imbalance of the computing devices' utilization of the radio frequency resources. The load balancer may select subsets of data that satisfy multiple filters, which may be used for determining a resource allocation for the computing devices. The selection of data satisfying multiple filters, and across a longer period of time, may provide for a more accurate identification of load balance across the computing devices.

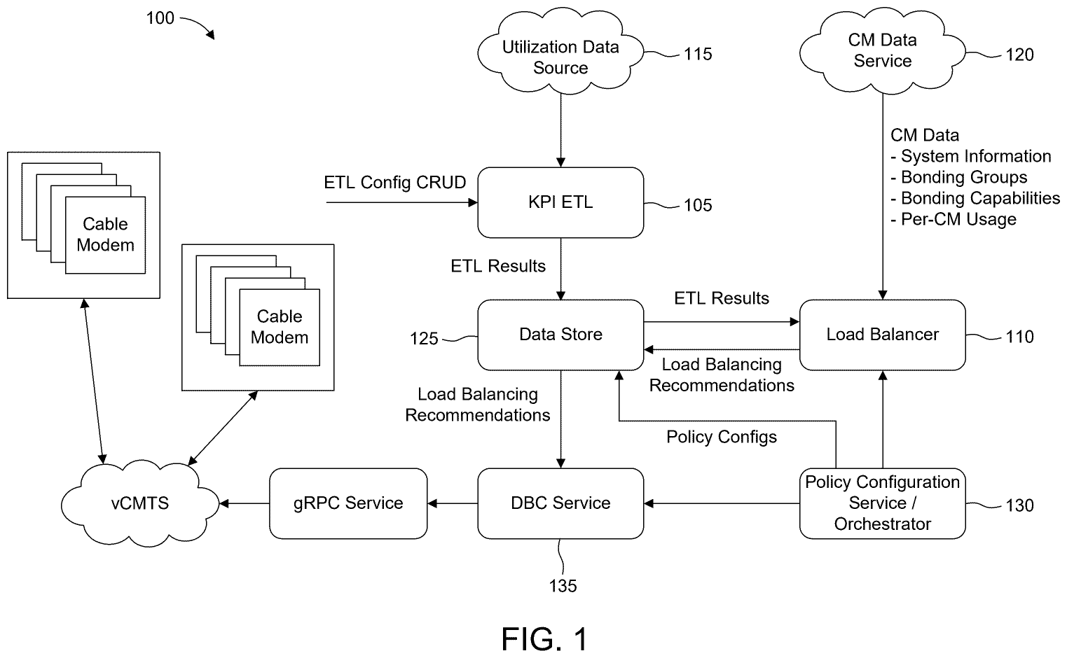

FIG. 1 shows a system 100 including an external load balancer (ETL) 110. The system may be an example of a radio frequency communication system, such as a vCMTS system. The system 100 may include a KPI ETL service 105. The KPI ETL service 105 may detect imbalanced loads across production service groups by consuming per-channel utilization time series from the utilization data source. The KPI ETL 105 may use the imbalance detection algorithm, top channel set detection algorithm, and KPI calculation methods discussed above. The configurations for the KPI ETL 105 may specify the scope, schedule, and enabled service groups. The results produced by this service may contain flags indicating if the service groups' channel utilizations are imbalanced. This flag, along with other identifiers may be used in the query to KPI ETL's API for selecting imbalanced service groups at different network topology levels.

The load balancer 110 may provide APIs for the load balancing algorithm and for triggering load balancing on certain service groups with policy configurations and create, read, update, and delete (CRUD) support for load balancing results in the data store. The load balancer 110 may integrate with the APIs of the CM data service for reading CM data for the load balancing algorithm. In some cases, the load balancer 110 is part of a cloud, or virtual network. The load balancer may determine reallocation of radio frequency resources for one or more computing devices such as the CM groups shown in FIG. 1. The reallocation of resources may be implemented in part by the vCMTS of FIG. 1.

The system 100 may also include a utilization data service 115. The utilization data service 115 may be a time series database (TSDB) that provides APIs for the KPI ETL to read over-time data including per-channel utilization at intervals (e.g., 15 seconds). The API parameters may support the caller to specify the time duration, and step size of the data.

The system 100 may also include a CM data service 120. The CM data service 120 may provide per-CM usage data based on samples collected over time for each device. The CM data service 120 may also implement data aggregation methods for preprocessing and summarizing per-CM usage data for the load balancer.

The system 100 may also include an external load balancer data store 125. This may be a data store that maintains KPI ETL results, load balancing recommendations, and policy configurations etc. The external load balancer data store 125 may ensure atomicity, consistency, isolation, and durability (ACID) in transactions and low frequency information updates for services and between services.

The system 100 may also include a policy configuration service and orchestrator 130. The policy configuration service and orchestrator 130 may provide facade for external load balancer services, CRUD APIs for policy configurations, and scheduling APIs and functionality for the calculations.

The system 100 may also include a DBC service 135. The DBC service 135 may transform the load balancing recommendations into batched, parallelized remote procedure calls (RPCs) to the vCMTS service gateway for changing the CMs' bonding groups with throttling, error handling, and scheduled retries in place.

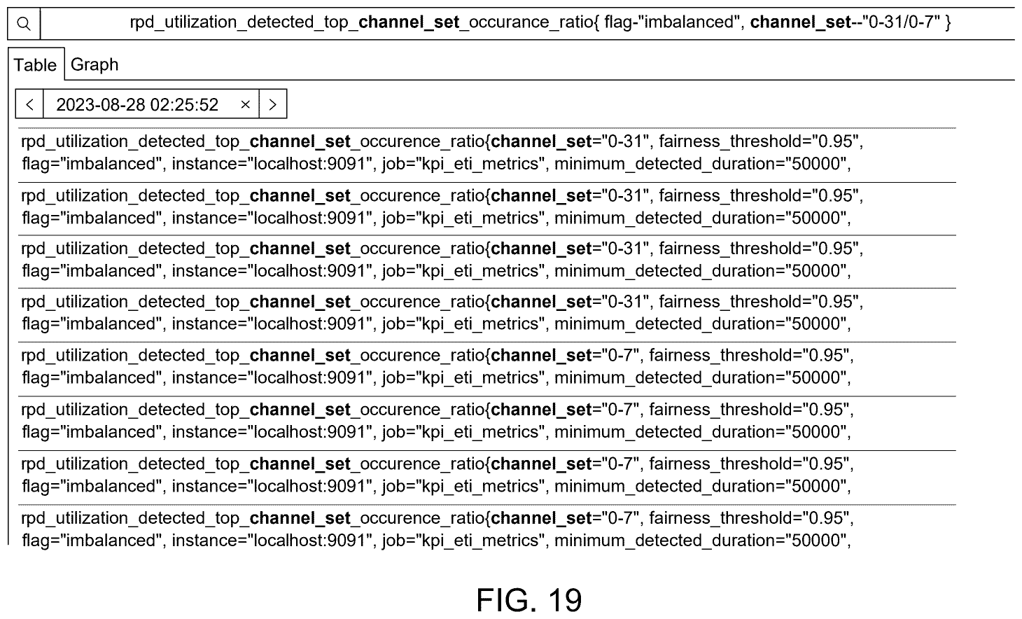

The system 100 may also include a monitoring system. The monitoring system may include TSDBs, endpoints (e.g., Prometheus endpoints) provided by the services, and metric dashboards (e.g., Grafana dashboards) provided by the services. An example metric scraped by an endpoint from KPI ETL is shown in FIG. 19.

Some data communication protocols, such as data over cable service interface specifications (DOCSIS), may include channel bonding support which may allow for scheduling of information in communication service flows over multiple channels concurrently, and may increase computing device usable capacity. A bonding group may specify references to a set of channels over which data is scheduled. In addition, the channel configuration, and the number of channels in the bonding group may be compatible with the bonding capabilities of the computing devices being served.

As the computing devices (e.g., cable modes (CMs)) may have variations in their bonding capabilities, such as based on technology versions and hardware of respective computing devices, the definition and assignment of bonding groups may facilitate balanced sharing of the spectrum resource across all users and maximizing the available spectrum resources for computing devices to reach their peak throughput. Because different computing device bonding capabilities may add variations to the maximum amount of spectrum resources computing devices can utilize, balancing the load of all computing devices within a service group may be viewed as stacking resources with different widths and thicknesses, where the width may represent a maximum carrier (e.g., single carrier-quadrature amplitude modulation (SC-QAM)) and bonding capability of a computing device (e.g., orthogonal frequency division multiplexing (OFDM)), and the thickness may represent an average utilization a computing device uses on the channels it bonds to. With this analogy, the goal of channel load balancing becomes apparent-building a “flat wall” with a variety of bricks.

Existing solutions today may include static and dynamic load balancing. A static load balancer may specify subgroups of computing devices which may share the same channel sets, and a static load balancer may perform bonding group assignments at a computing device's registration time. This may improve resource sharing across the available spectrum on a computing device-count basis. However, different users may have different service tiers and different usage levels and behaviors. Although the static load balancer is simple and robust, it may not account for real-time utilization at per channel level and per user level to make the optimal decision, which may result in non-optimal spectrum resource efficiency.

A dynamic load balancer of a computing device or system (e.g., a CMTS) may adjust computing devices' bonding groups to dynamically maximize resource efficiency based on real-time computing device counts or utilization. To operate the dynamic load balancer effectively, accessibility to sophisticated data such as a computing device's make/model/device-class, policy configurations, and known computing device bugs may be utilized. However, the built-in dynamic load balancer also includes challenges and limitations to access such rich data, resulting in risks in production of encountering device bugs and customer service impacts. As such, dynamic load balancing may be disabled because of such risks.

According to the present disclosure, a cloud-based, external load balancer may solve the problems observed in both static load balancers and built-in dynamic load balancers, such that the load balancer produces optimal results by gaining access to key operation data while being robust, reliable, and low-cost. This is made possible by a virtualized load balancing system (e.g., a virtualized cable termination system (vCMTS) and respective application programming interfaces (APIs)), and rich telemetry for service groups and computing devices (e.g., CMs). In addition, this functionality may be separated from the vCMTS, which may reduce the development and release cycles of load balancing features and bug fixes, and which may allow for execution at flexible schedules and scalability.

In pre-DOCSIS 4.0 communication protocols, there may be less than or equal to 2 radio frequency (e.g., OFDM) channels on the downstream, and computing devices may be bonded to each of the configured channels. On the upstream, the spectrum configuration may allow for all non-DOCSIS 2.0 computing devices to fully bond to all allocated radio frequency channels (e.g., SC-QAM channels and orthogonal frequency division multiple access (OFDMA) channels). Since the downstream and upstream schedulers may balance the bandwidth allocations to computing devices' bonded channels in real-time, the external load balancer may be designated to focus on ensuring fair-sharing of capacity among the downstream channels. Having access to rich, multi-day historical data may allow the load balancer of the present disclosure to recognize the demand of rebalancing for each service group over an extended period and minimize the frequency of changes in the network.

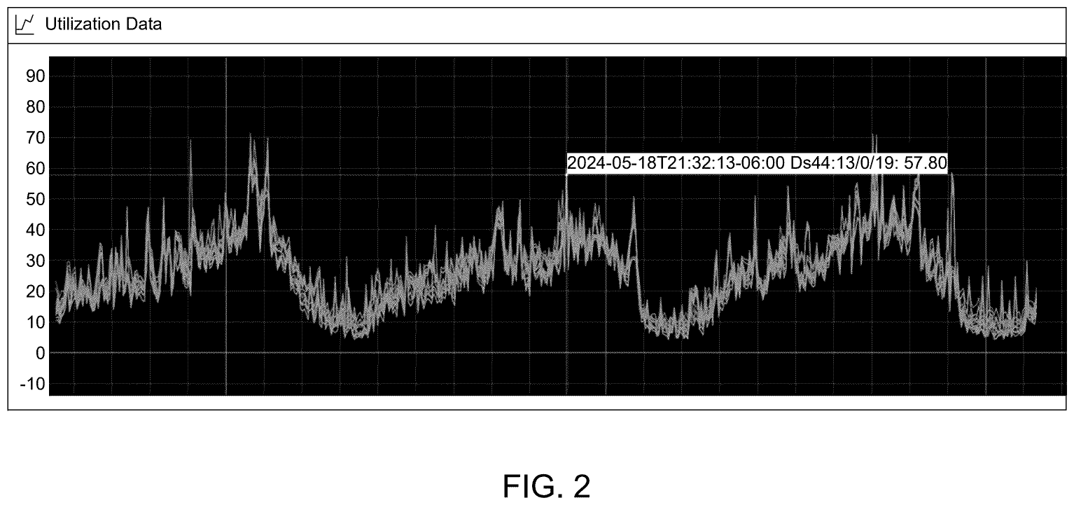

The DOCSIS per-channel utilization may be available at predefined intervals (e.g., 15-second intervals) across different service groups and channel types. This information may be used for researching and understanding capacity consumption behaviors. In a well-balanced service group, the utilization may be uniformly distributed across all downstream (e.g., SC-QAM) channels. Periodic, daily demand changes may appear in the time series graph as shown in FIG. 2.

In the utilization over-time graph in FIG. 2, the x-axis may represent the time, and the y-axis may represent the utilization percentage at a given data capturing moment. For efficiency, the utilization sample interval may be increased from 15 seconds to 300 seconds, which may preserve most of the information needed by the analysis while significantly reducing the data input/output (I/O) and processing loads.

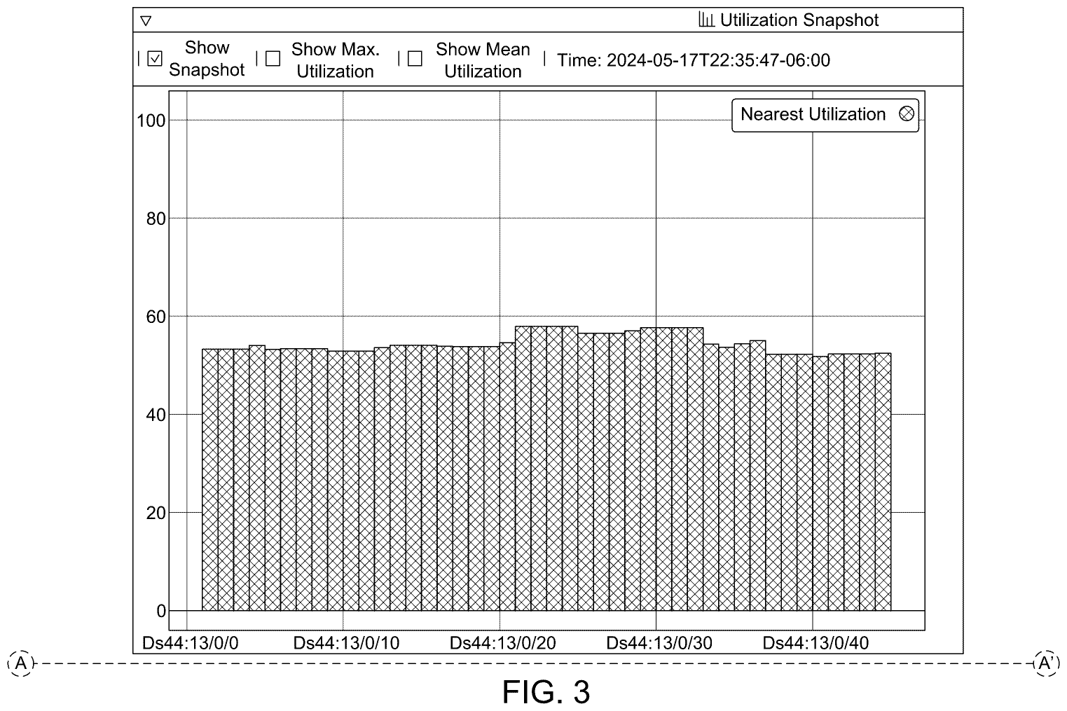

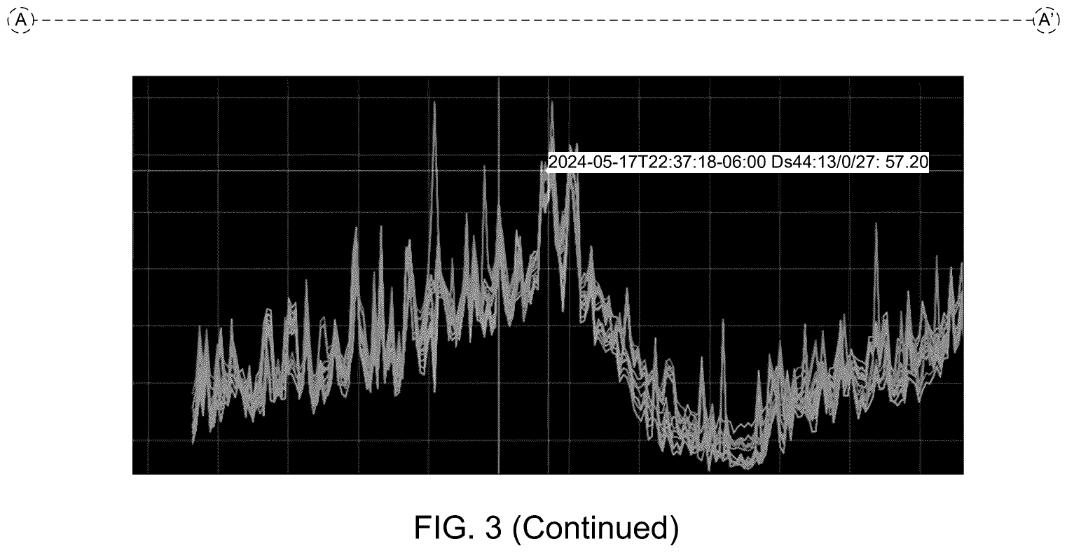

By inspecting further into the snapshots of utilization distributions of a service group, as shown in FIG. 3, the utilization may be balanced across all downstream (e.g., SC-QAM) channels (bars from left to right in the bar chart) during peak hours where imbalanced loads may cause the most impact to customer experience. Both FIGS. 2 and 3 may demonstrate the characteristics of a well-balanced service group.

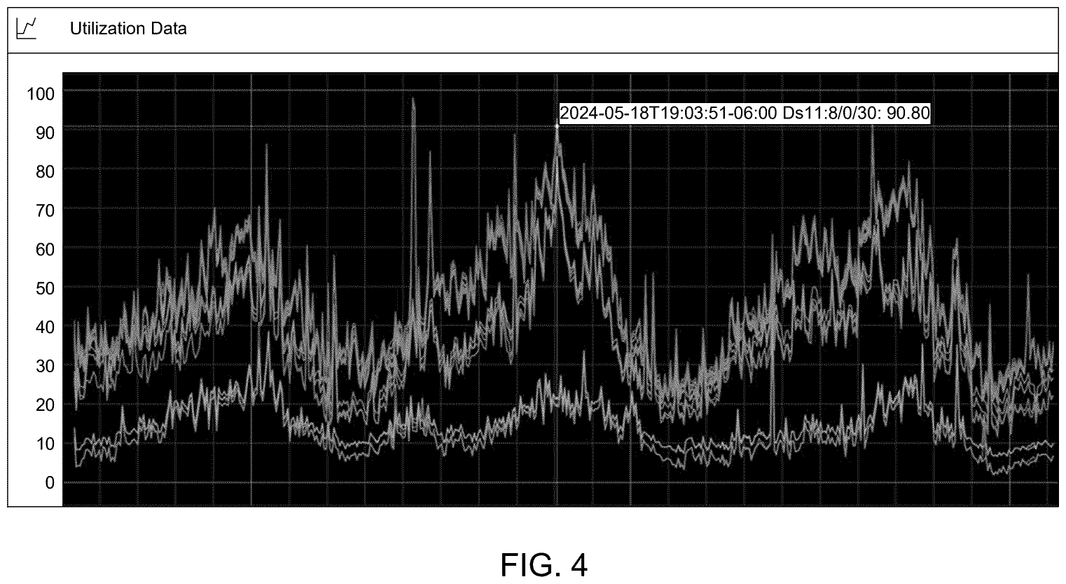

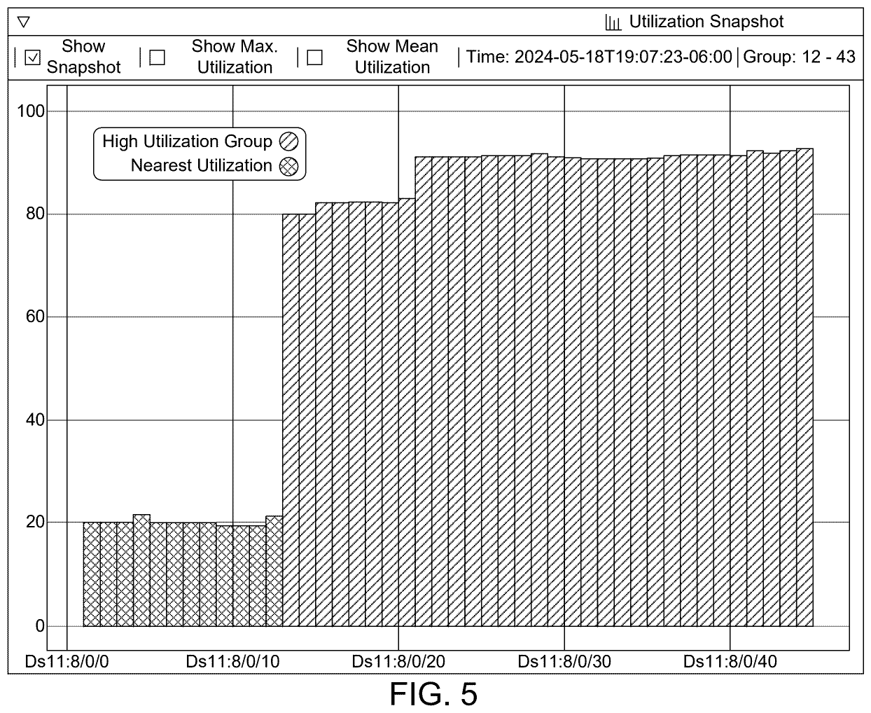

In comparison, a service group that is experiencing downstream (e.g., SC-QAM) channel utilization imbalance may show prominently higher utilization across certain channel sets compared to other channels as shown in FIGS. 4 and 5.

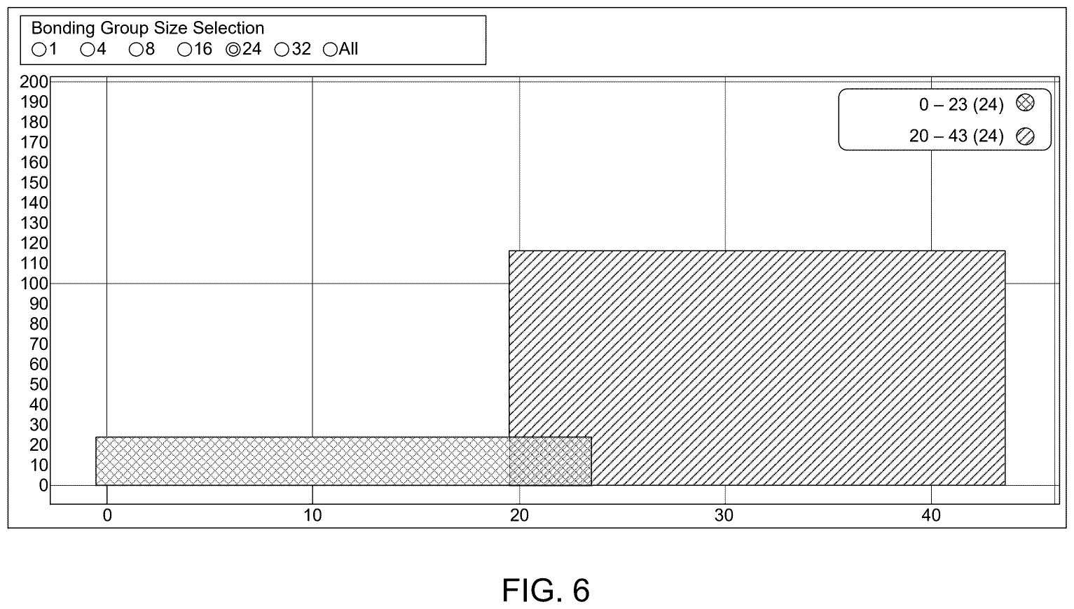

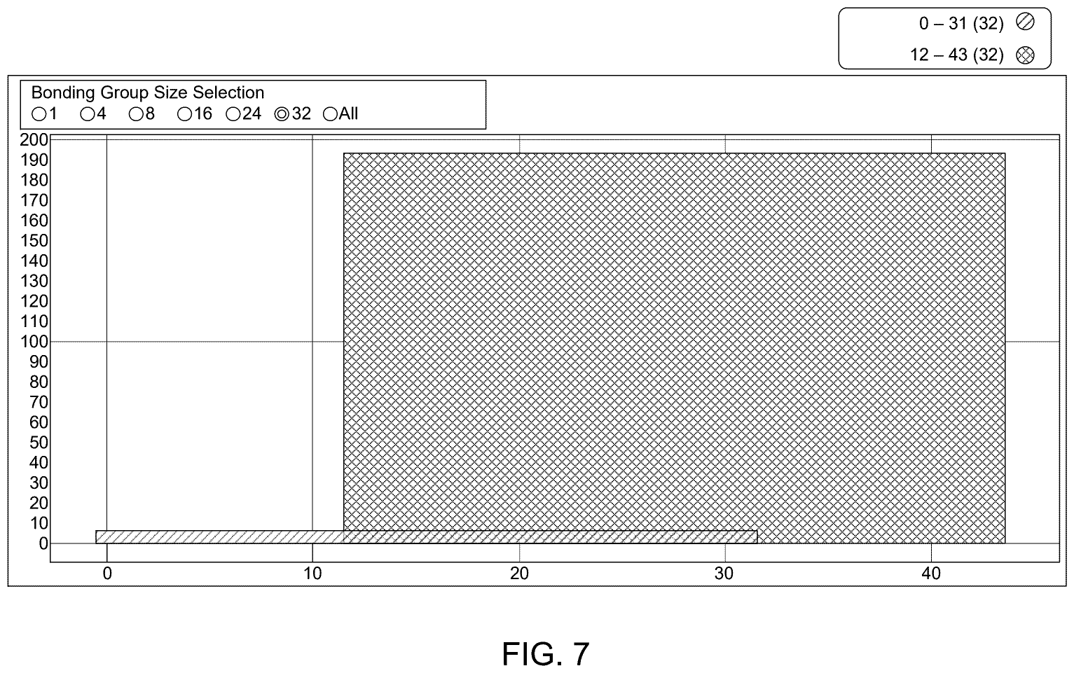

The 24-channel and 32-channel bonding groups located at the upper end of the downstream SC-QAM spectrum may appear as the cause of the imbalanced utilization. This assumption is further supported by the distribution of CM counts across bonding groups as shown in FIGS. 6 and 7.

The charts in FIG. 6 may represent the device counts of two 24 SC-QAM channel bonding groups, and the charts in FIG. 7 may represent the aggregated devices counts of two 32 SC-QAM channel bonding groups and two 32 SC-QAM plus one OFDM channel bonding groups. In FIG. 6, the lower end bonding group may be assigned to 22 CMs, whereas the upper end bonding group may be assigned to 117 CMs. In FIG. 7, the lower end 32 SC-QAM channels are assigned to 6 computing devices (e.g., CMs), whereas the upper end 32 SC-QAM channels are assigned to 191 computing devices. This may be a case where the static load balancer is having challenges to balance the load by distributing CM counts evenly across the spectrum by their maximum bonding capabilities.

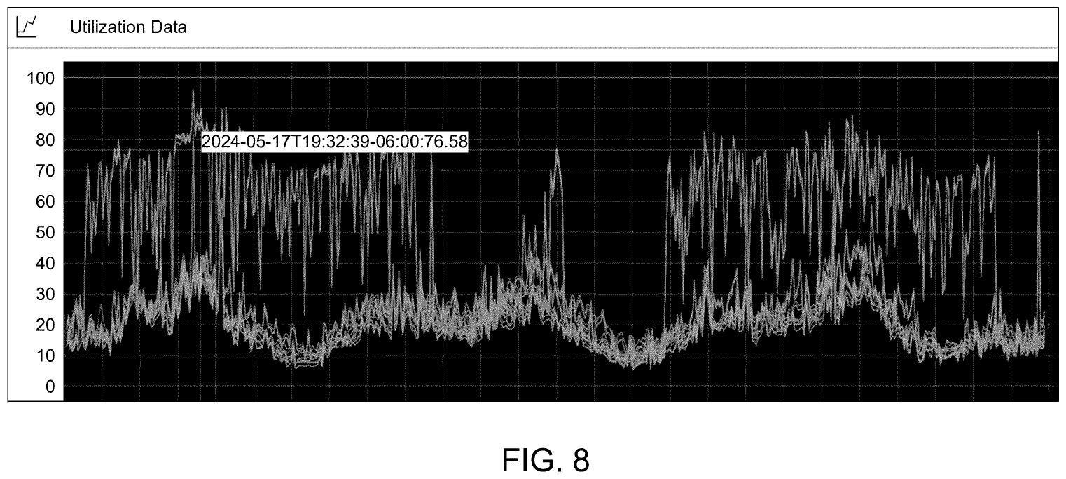

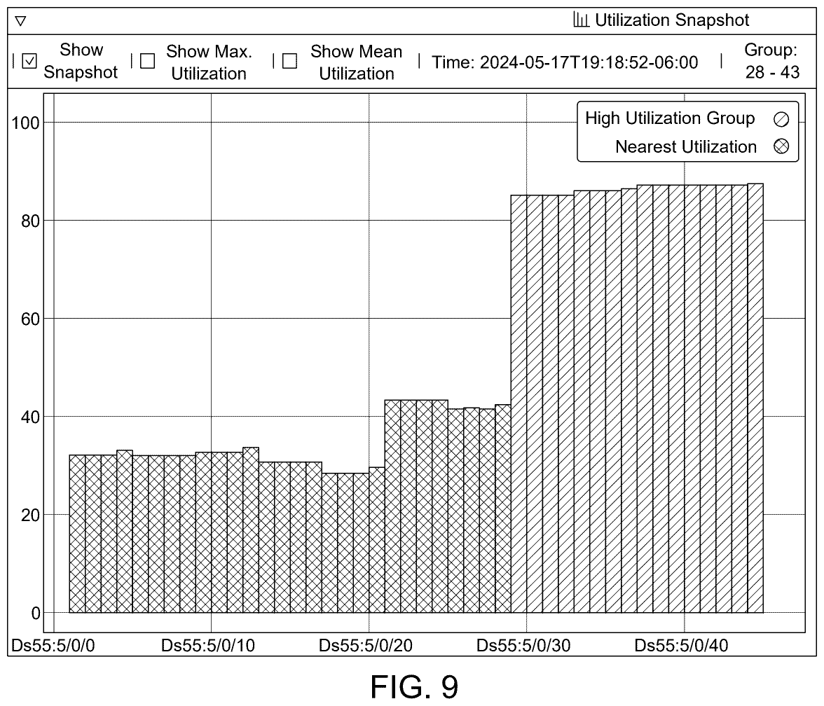

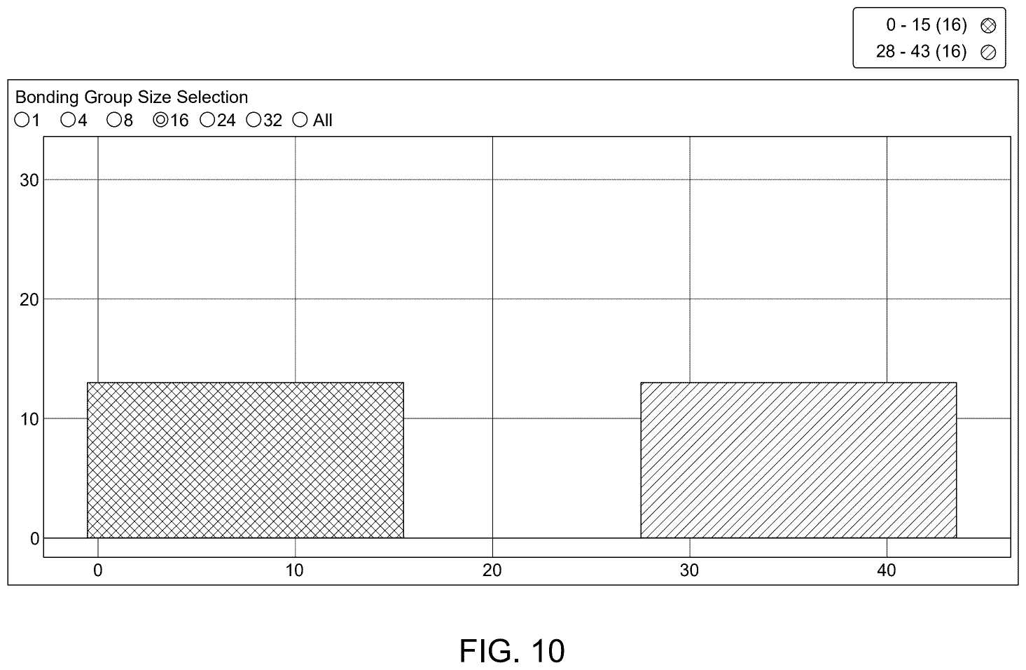

Another example presented by FIGS. 8 and 9 may show that a 16-channel bonding group at the upper end of the SC-QAM spectrum is highly utilized and causes imbalanced load. However, FIG. 10 may indicate that all 16-channel CMs are allocated evenly across two 16-channel bonding groups. This observation may suggest that different customer demands cause imbalanced loads as expected, but the static load balancer may be unable to provide improvements as it does not consider per-device utilization and usage behaviors.

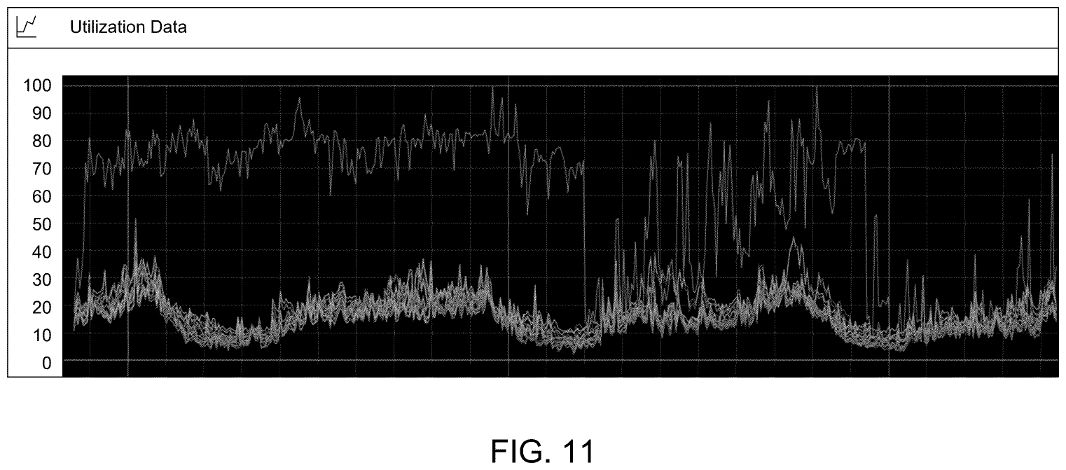

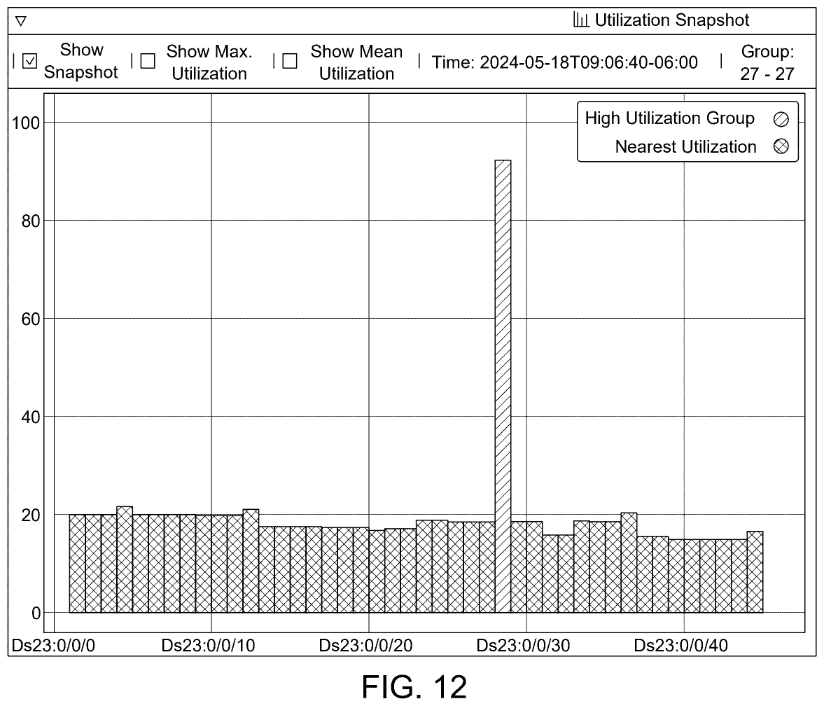

In addition to bonding groups showing imbalanced loads, the downstream primary (e.g., SC-QAM) channels may be saturated under certain conditions, such as: Devices are staying in partial service due to other issues; and abnormal DOCSIS 2.0 or set-top box devices. A detected example of a highly utilized primary channel may be shown in FIGS. 11 and 12. In such cases, the load balancer may be unable to improve the imbalanced loads. However, it may be valuable to be able to identify, alert, and track such events for targeting and isolating primary channel utilization issues and suggesting improvements such as recommending customer device upgrades.

With understanding of the characteristics of the per-channel utilization and the causes of imbalanced loads, the detection process may be automated by designing algorithms to audit all service groups at full production scale. This may facilitate effectively selecting the target service groups for load balancing, reducing the overall cost of the external load balancer, and calculating load balancing key performance indicators (KPIs) for monitoring.

The imbalance detection algorithm may be developed as part of a software library to be used by an extract, transform, and load (ETL) service. The algorithm may be capable of:

Detecting the imbalanced loads among utilization snapshots across the channels; Summarizing the percentage of time a certain service group is imbalanced; Identifying the top channel set that caused the imbalance within the utilization data duration and computing the distribution of percentages of time each channel set contributed to the imbalance; and Calculating KPIs related to channel utilization and load balancing.

The first step of the algorithm may be to calculate the fairness measure across a snapshot of downstream (e.g., SC-QAM) channels' utilization values. The fairness measure may be Jain's fairness index, defined as:

$$\frac{1}{1 + \hat{{c}_{v}^{2}}} , \qquad ( 1 )$$

where [symbol] is a sample coefficient of variation.

The Jain's fairness index may effectively include the fairness value to

$$[ \frac{1}{n} , 1 ] , or [ \frac{100}{n} , 100 ]$$

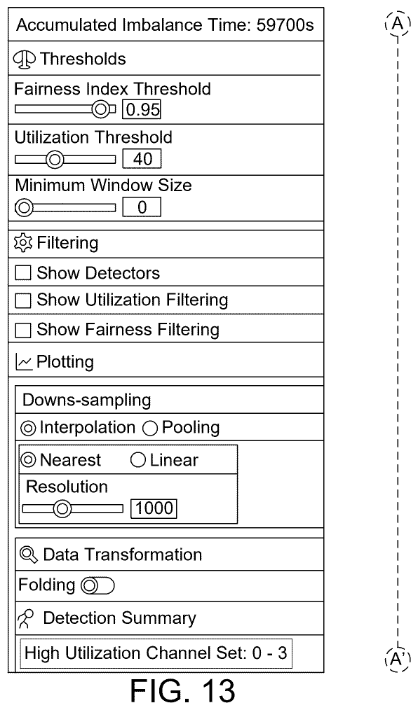

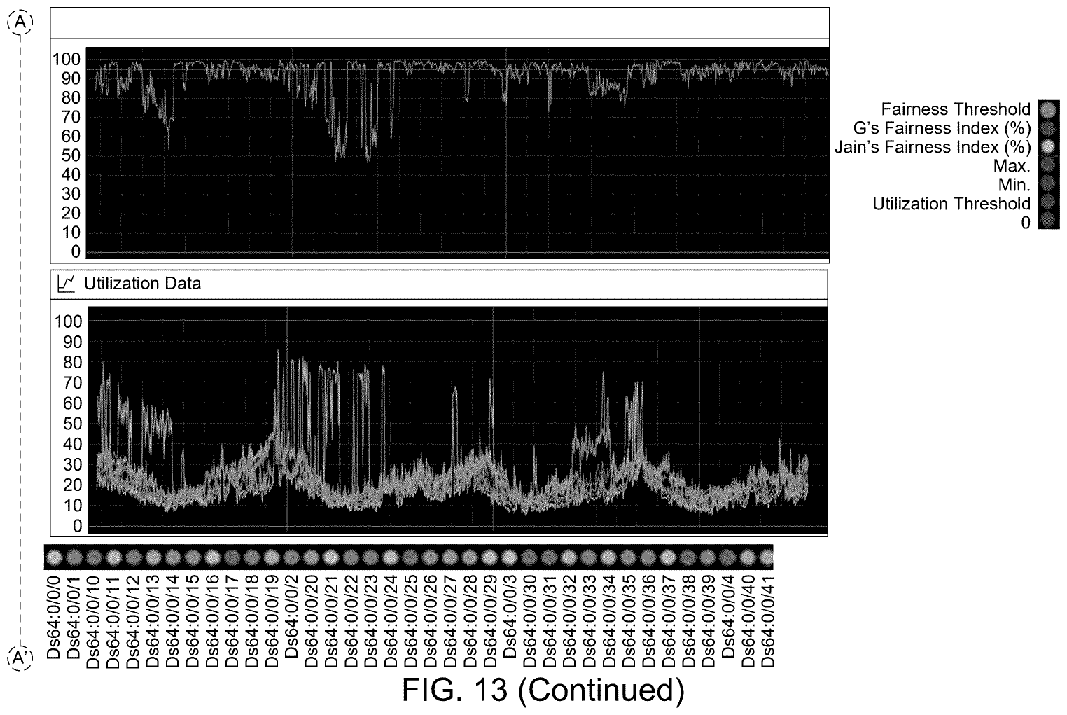

if its value is multiplied by 100 as visualized in FIG. 13, where n may be the number of downstream (e.g., SC-QAM) channels. This may assist in defining the thresholds for the fairness measure.

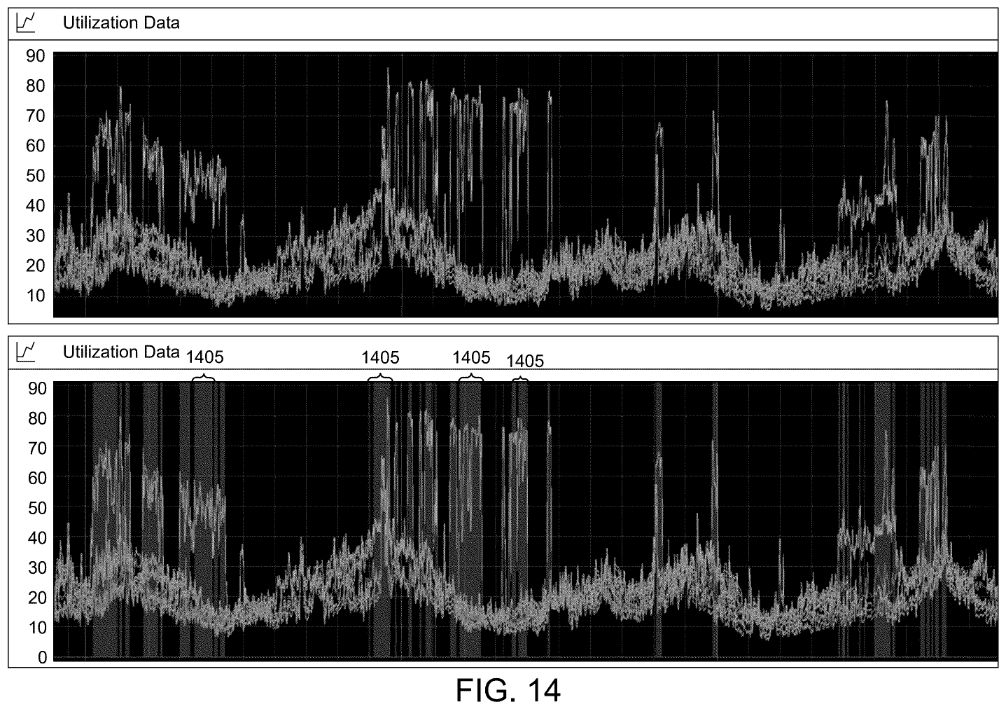

To detect imbalanced loads, the algorithm may increment through the following steps: Selecting time windows with significant overall utilization as S₁. An example may be visualized in FIG. 14 (regions 1405). When the overall utilization is low, the impact from imbalanced loads may be small, and the fairness measure may not be meaningful. Selected time windows may include a maximum (or mean) utilizations across all interested channels above the specified threshold, such as 35%.

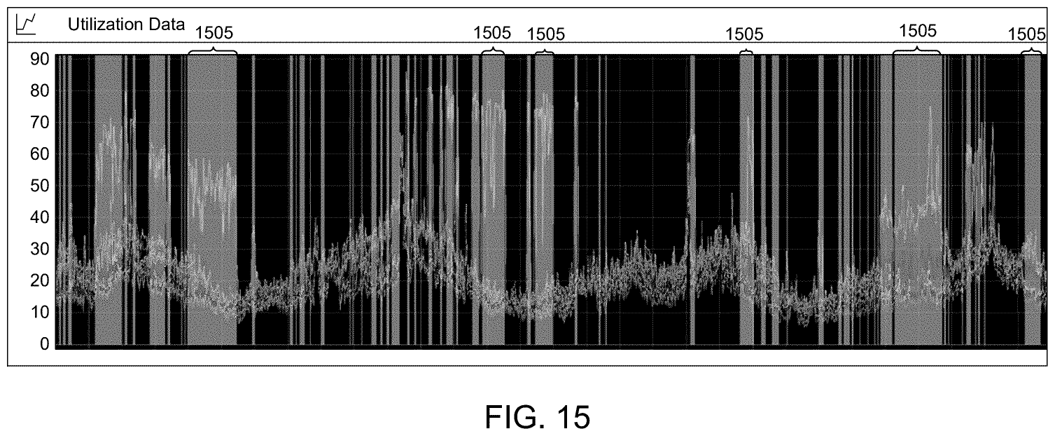

The algorithm may also include selecting the time windows within the multivariate utilization time series which have their Jain's fairness index values less than or equal to a specified threshold, such as 90%. These time windows are labeled as S₂. An example may be visualized in FIG. 15 as regions 1505.

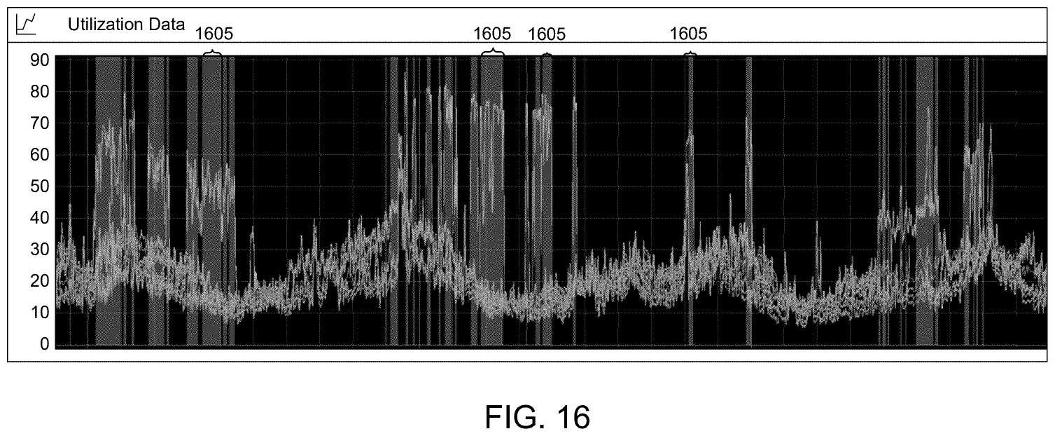

The algorithm may also include computing the intersection time windows of S₁ and S₂ as S₃. The S₃ may contain the regions of interest (ROIs) of the imbalance observations on a service group. An example may be visualized in FIG. 16 as regions 1605.

The algorithm may also include filtering the service groups by the total identified imbalance time indicated by the S₃. For example, the threshold may specify that the total time of S₃ is greater than or equal to 30%.

This algorithm may be configured to consume arbitrary duration of the multivariate utilization over-time data, but a 3-day or a 7-day data duration may be utilized for considering non-temporary, sustained imbalance events.

The detection results may suggest two categories of imbalance types and potential causes: 1) Exceptionally high and lasting utilization on small bonding groups or primary channels. This may be caused by users with sustained high demands (top-talkers) while using devices (e.g., CMs) with limited bonding capabilities. This may sometimes be caused by devices with high bonding capabilities and high provisioning rates staying in partial service mode (caused by other issues).

The detection may also suggest another imbalance type: moderate utilization imbalance caused by the same channel set(s) over a long duration. This may be caused by limitations in the static load balancer where the devices are not evenly distributed across the bonding groups and/or different user activity levels or provisioning rates are not considered.

To identify the above two types, for instance, the algorithm's thresholds may be configured as: Abnormal utilization imbalance identification. High utilization threshold may be included for the first step in the detection algorithm, for example, 80%, to target saturated small bonding groups and/or primary channels. The algorithm may also be configured with a low fairness index threshold for step 2, for example, 80%, to target extremely imbalanced utilization patterns. The algorithm may also be configured with low-moderate total imbalance time threshold, for example, 15% of the utilization data duration.

Other (common) utilization imbalance identification for the algorithm may include: moderate utilization threshold for step 1 in the detection algorithm, for example, 30%; high fairness index threshold for step 2 in the detection algorithm, for example, 95%; and high total imbalance time threshold, for example, 35% of the utilization data duration, to target sustained imbalance detection.

In addition to the imbalance detection algorithm, an algorithm may also identify the channel set that caused the utilization imbalance, which may be referred to as a “top channel set.” An example “top channel set” may be identified and highlighted as shown in FIG. 5, FIG. 9, and FIG. 12.

Identifying the top channel sets that caused the imbalanced utilization may not require per-device usage data, and may be performed by executing the following steps:

For each utilization snapshot of all radio frequency (e.g., SC-QAM) channels, kernel density estimation (KDE) may be used to calculate discrete distribution values from the estimated probability density function (PDF). Peak finding may be used to identify the top utilization channel set in each utilization snapshot of all channels. The channel set which appears as the top channel set in the greatest number of utilization snapshots may be determined.

The KDE may be defined as:

$$( x ) = \frac{1}{n h} {\sum }_{i = 1}^{n} K ( \frac{x - {x}_{i}}{h} ) , \qquad ( 2 )$$

where n may be the number of observations, K may be the kernel—a non-negative function, and h may be the bandwidth—a positive number that defines smoothness of the density plot.

For the bandwidth, Scott's rule may be used. Scott's Rule is defined as:

$$h \approx 1.06 \cdot \hat{σ} {n}^{- 1 / 5} , \qquad ( 3 )$$

Finally, the Epanechnikov kernel may used:

$$K ( u ) = \frac{3}{4} ( 1 - {u}^{2} ) \cdot {1}_{\{ \vert u \vert < 1 \}} , \qquad ( 4 )$$

where u may be the standardized distance between a data point and its estimation point, and |u|<1 may define the support where K(u)=0 when the condition is false.

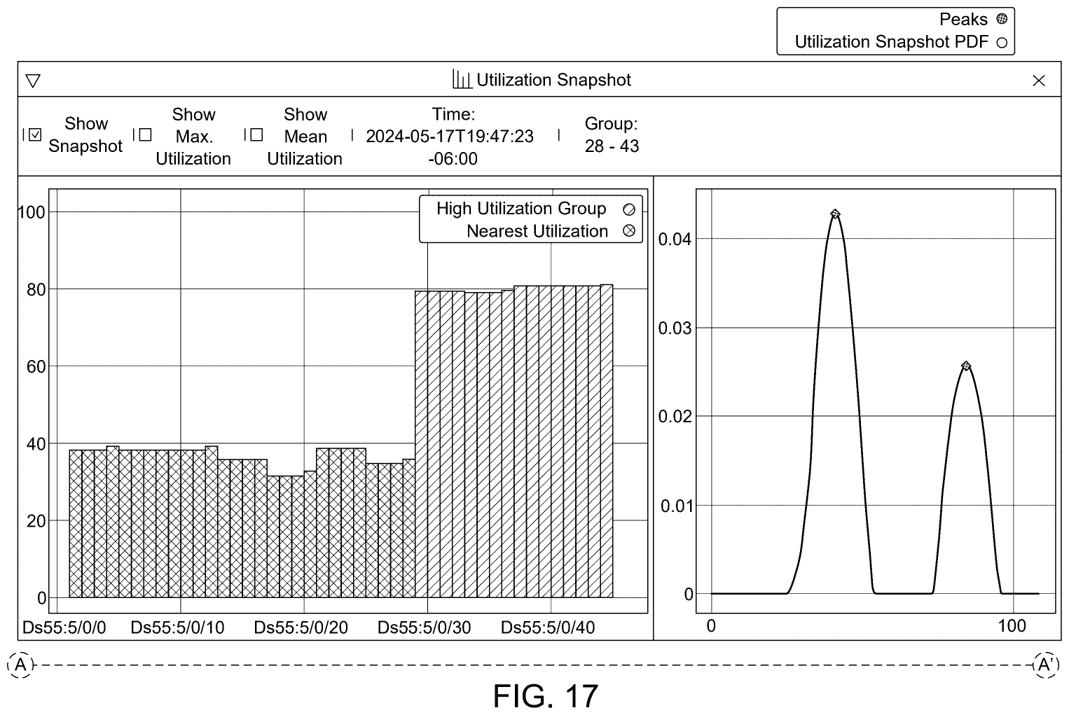

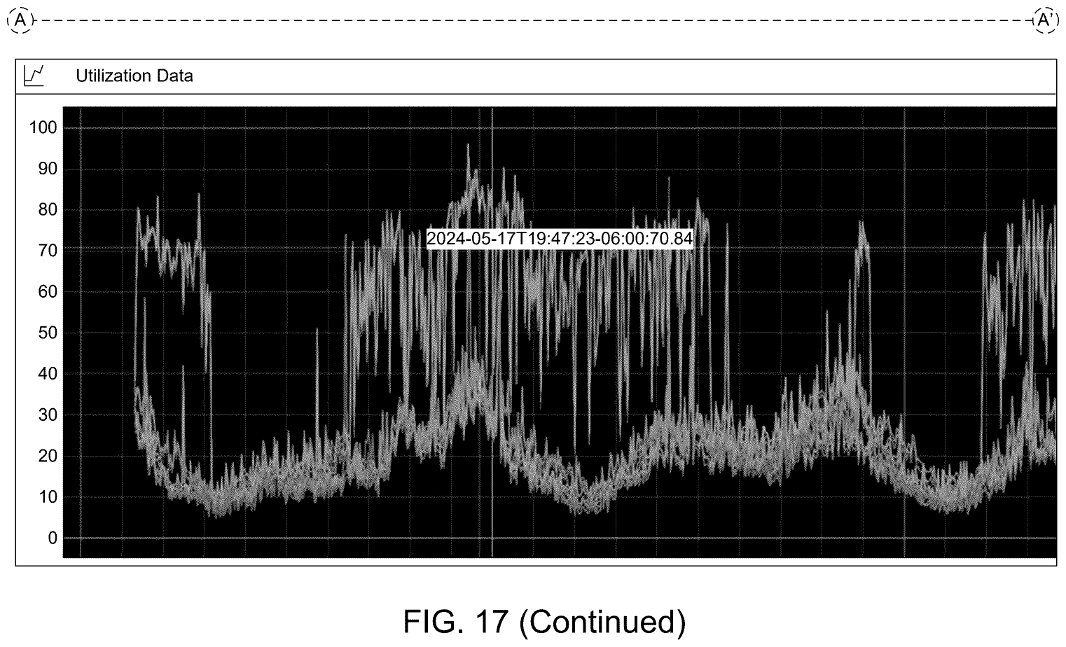

The algorithm may use KDE, PDF, and peak finding to perform 1-D data grouping/clustering at extremely high performance. Within each utilization snapshot, the channels may be associated with the groups that they belong to by identifying their closest peaks found in the discrete distribution values from the PDF. This may be visualized in the top-right corner of FIG. 17 along with the utilization over-time data and a utilization snapshot of 44 downstream SC-QAM channels.

In addition to imbalance detection and top channel set detection, calculating KPIs may be beneficial for scoring and continuous monitoring. The KPIs included in the library for imbalance detection may include: the mean utilization of all samples of all channels; the 98^{th} percentile of all channel samples' mean utilization values, which may provide insights into the utilization that a service group will experience within the busiest 30 minutes during the day; the mean utilization of all samples of the identified channel sets caused the imbalance, where comparing the top channel sets mean utilization and other channels' mean utilization may indicate the degree of imbalance from mean utilization point of view; the 98^{th} percentile of the identified channel sets' mean utilization values, where comparison of the 98^{th} percentile utilizations of the top channel set, and other channels may indicate the degree of imbalance from the busiest (e.g., 30 minutes) point of view; detected imbalance duration over the total data duration ratio, which may assist in prioritizing the detected channel sets; fairness calculation results; mean of all snapshot fairness values over time; mean of snapshot fairness values within detected time windows; coefficient of variation of mean channel utilizations over time; coefficient of variation of mean channel utilizations within detected time windows; mean standard deviation of the snapshot utilization values over time; mean standard deviation of the snapshot utilization values within detected time windows; and channel set detection results, which may be a list of channel sets. The channel sets may be identified by their start channel index and end channel index. The detected sample counts may be calculated and included for each channel set.

A performant software program may allow for scaling at low cost with high confidence. For reusable and easily testable code such as imbalance detection, top channel set detection, and the KPI algorithms, performance optimization may result in high return at a reasonable development cost. In addition, benchmark tests may assist in tracking performance changes in relation to the code changes and are a valuable addition to the algorithms' test suite. Below are benchmark results:

TABLE 1
Imbalance Detection, Top Channel Set Detection, and KPI Calculation
Benchmark Results (Single-Core, Confidence Level = 95%)

| Test | Lower Bound | | Mean | | Upper Bound | |
|---|---|---|---|---|---|---|
| Imbalance Detection, Top | 47.536 | μs | 48.159 | μs | 48.913 | μs |
| Channel Set Detection, and KPI | | | | | | |
| Calculations (44 channels, 7- | | | | | | |
| Day Utilization, 5-Minute | | | | | | |
| Interval) | | | | | | |
| Time Window Intersections, | 14.226 | μs | 14.619 | μs | 15.111 | μs |
| 1,000 × 1,000 Windows, | | | | | | |
| O (max{m, n}}) | | | | | | |
| Time Window Intersections, | 169.61 | μs | 202.76 | μs | 246.71 | μs |
| 10,000 × 10,000 Windows, | | | | | | |
| O (max{m, n}}) | | | | | | |
| Time Window Intersections, | 1.3363 | ms | 1.3697 | ms | 1.4078 | ms |
| 100,000 × 100,000 Windows, | | | | | | |
| O (max{m, n}}) | | | | | | |

The imbalance detection and KPI algorithms may be performant and allow for large scale computing at a low cost, especially considering the nature of decomposed workloads in a radio frequency communication system (e.g., vCMTS) where this compute resource may be independent of the data plane resource responsible for forwarding and scheduling traffic.

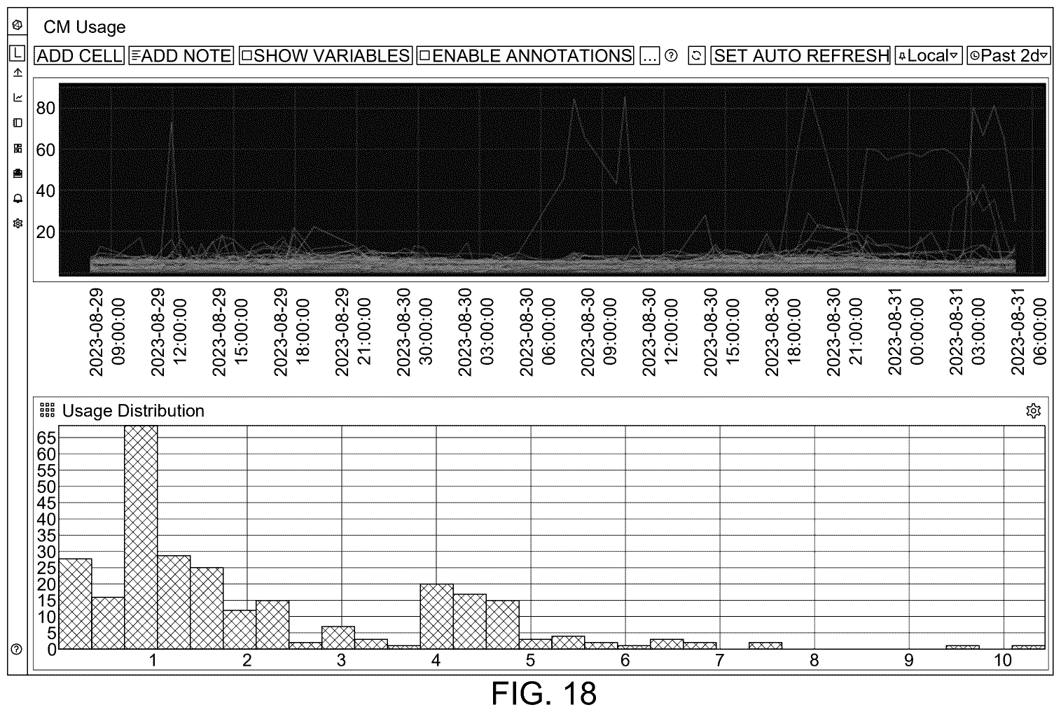

A prerequisite for utilization-based load balancing may be per-device usage over-time data. This data may be used by the load balancing algorithm to weight users' impact on their devices' compatible channel sets and to assign bonding groups to the devices. As a cost-effective solution, the periodically collected and stored 64-bit interface octet counters from computing devices may be used to calculate their bandwidth usage on each channel. A basic visualization of the collected data is shown in FIG. 18.

For example, 3 days of computing device usage data may be used for calculating the aggregated “scores” for the computing devices. The common aggregation methods may include: Over-time bandwidth usage mean; a certain quantile (e.g.: 0.8) of the over-time bandwidth usage; mean/quantile of the usage samples during peak hours; and mean/quantile of usage samples weighted by time-of-day factors.

The radio frequency communication system (e.g., vCMTS) may provide operational flexibility, observability, and APIs for distributing its control functionalities anywhere. A conventional dynamic load balancer may not have access to information of device vendor, model, firmware version, and long term per-computing device usage data. Therefore, it relies on and reacts to short-term data and limited information to make dynamic improvements. Lack of the full data perspective often results in challenges such as: over-correction or under-correction by relying on short-term data, resulting in unideal load balancing outcome; “Discovery” of unknown service-affecting computing device bugs that exist on certain device models or firmware versions because the dynamic bonding changes (DBCs) are applied in a model/make agnostic fashion; and frequent DBC changes which may decrease the stability of the service; a lack of observability for the load balancing decision making and reasoning. For example, there may be a lack of knowledge of the load balancing KPIs, and before and after KPI changes for feedback. Further, the load balancing decision may not be explainable as the internal weighting and processing of the per-computing device utilization data is unknown to the operator.

In addition, a conventional built-in load balancer's software updates/patches may be packaged along with the entire software built for the communication system (e.g., CMTS). This may closely tie the software release cycles of the load balancer to a much larger system and makes it challenging and time consuming to develop, release and test improvements based on immediate feedback from deployment.

The capabilities of the external load balancer may include. consuming long-term per-computing device usage data to maximize spectrum efficiency gain. The external load balancer may also provide accounting for flexible policy configurations that can easily be tuned over time and device vendor/model/firmware information in the load balancing algorithm. The external load balancer may also provide accounting for bandwidth demands of devices excluded by policy, while maintaining bonding groups. The external load balancer may also provide recommendations and load balancing changes at low frequency to minimize the number of dynamic changes in the network, such as once per day in a service group. Further, The external load balancer may also provide load balancing when imbalance is detected. The external load balancer may also provide the tracking of load balancing recommendations with associated input data for visibility and potential rewinding analysis for troubleshooting. The external load balancer may also be distributed, decoupled from the communication system software build, and elastically scalable.

A utilization-based load balancing algorithm may consume the user activity levels as scores. This may allow the load balancer to take advantage of various aggregation methods implemented by the per-computing device usage data service. This may also allow the load balancer to be used as a computing device count-based load balancer when per-computing device usage data is not available, and the load balancer may be supplied with a static score of 1 for all computing devices.

The load balancing algorithm may use the existing, configured bonding groups for the service group. This may allow the bonding group recommendations produced by the external load balancer to be seamlessly applied without making service group level configuration changes that are more complex to perform without service impact.

This algorithm may perform the following steps: place the existing bonding groups into distinct categories by bonding group size (for different computing device capabilities), where each category may maintain a max binary heap where the order of the bonding groups is maintained by their available resources (in descending order).

The algorithm may also include sorting the computing devices based on their per-channel usage in descending order. Those that have high per-channel usages may be more likely to cause imbalance and are allocated first. The algorithm may also include iterating through computing devices along with their activity level data. The algorithm may also include matching a computing device to the bonding group set (candidate bonding groups) by its bonding capability. The algorithm may also include popping from the heap that is mapped from the bonding capability, which may suggest a bonding group with the most available resource within its category. The algorithm may also include assigning the bonding group to the computing device and update the bonding group's available resource metric. The algorithm may also include placing the bonding group back to the heap, the order of the bonding groups in the heap may automatically adjust. The algorithm may also include continuing steps 3-6 for each computing device.

The time complexity for the algorithm may be O (n⋅log n), where n is the number of computing device (e.g., CMs), and its high-level performance measurements are listed below.

TABLE 2
Load Balancing Algorithm 1: Benchmark Results
(Single-Core, Confidence Level = 95%)

| Test | Lower Bound | Mean | Upper Bound |
|---|---|---|---|
| 600 CMs | 446.31 μs | 455.72 μs | 466.88 μs |
| 1,000 CMs | 713.97 μs | 720.86 μs | 728.83 μs |

Since the number of selected target service groups is small after imbalance detection, this algorithm may be performant. Considering the nature of workloads in a communication system (e.g., vCMTS) environment where this compute resource may be independent of the data plane resource and becomes a question of compute cost and associated value as opposed to competition for scarce compute resources.

Additionally or alternatively, a load balancing algorithm may recommend bonding groups for optimal load balancing results. Changing the configurations of bonding groups on a service group may incur significantly higher complexity for hit-less, dynamic operations.

This algorithm may include receiving the list of computing devices along with their usage and bonding capabilities as the input. The algorithm may also include sorting the computing devices based on their per-channel usage in descending order. Those having high per-channel usages may be more likely to cause imbalance and may be allocated first. The algorithm may also include maintaining an array of values that represent each channel's usage score, e.g., starting from 0.

The algorithm may also include iterating through each computing device and use a moving window that matches the computing device's bonding capability to identify a contiguous set of channels that has the least usage and meets the primary channel requirement and policy constraints; and fill the computing device usage to the selected set of channels.

Step 4 may create a set of bonding groups and bonding group assignments for improved load balancing. To enforce a maximum number of bonding groups limit, the algorithm may include sorting the generated bonding groups by the number of computing devices assigned to them; iterating through the bonding groups, reduce the number of bonding groups to the limit number if needed, while ensuring computing device bonding capabilities are supported; collect the remaining set of bonding groups after the previous reduction step; and re-execute step 3 with an additional constraint where the candidate bonding groups are the remaining bonding groups produced by the previous step.

This algorithm may be used to reduce the number of bonding groups in the service group configuration, reducing the complexity of the configuration when necessary.

A device exclusion policy may ensure the load balancing recommendations accommodate potential risks of DBC instability of certain computing device models. Meanwhile, the load balancing algorithm may ensure that the utilizations of devices including the excluded devices are considered. Both previously discussed load balancing algorithms may apply device exclusion policy. In the first algorithm, this may be accomplished by including the following steps before the step 1: identify computing devices to be excluded from load balancing by matching their model, make, bonding capability, and firmware version. Another step may include maintaining a hash map with key being the bonding group name and the value being the bonding group instance; for each excluded computing device, instantiate and insert its bonding group to the hash map if it has not been inserted previously, and subtract its score from the bonding group's available resource. Another step may include combining the bonding groups initialized in the previous step with other existing bonding groups (with default initialization) in step 1 of the first load balancing algorithm.

Similar steps may be inserted between the step 3 and 4 of the second load balancing algorithm to ensure the bonding groups used by the excluded computing devices exist, and the usage scores of excluded devices are considered after the initialization of the channel usage scores. These exclusion policies may change over time as modem firmware fixes are obtained and certified are also much easier to manage as an external micro-service in a virtualized CMTS.

Results of the load balancing algorithms are described below, in connection with “before” and “after” utilization distributions and the improvements provided by two load balancing algorithms. The improvements may be represented as imbalanced service groups by KPI, and may be represented visually in the figures where each color represents a modem.

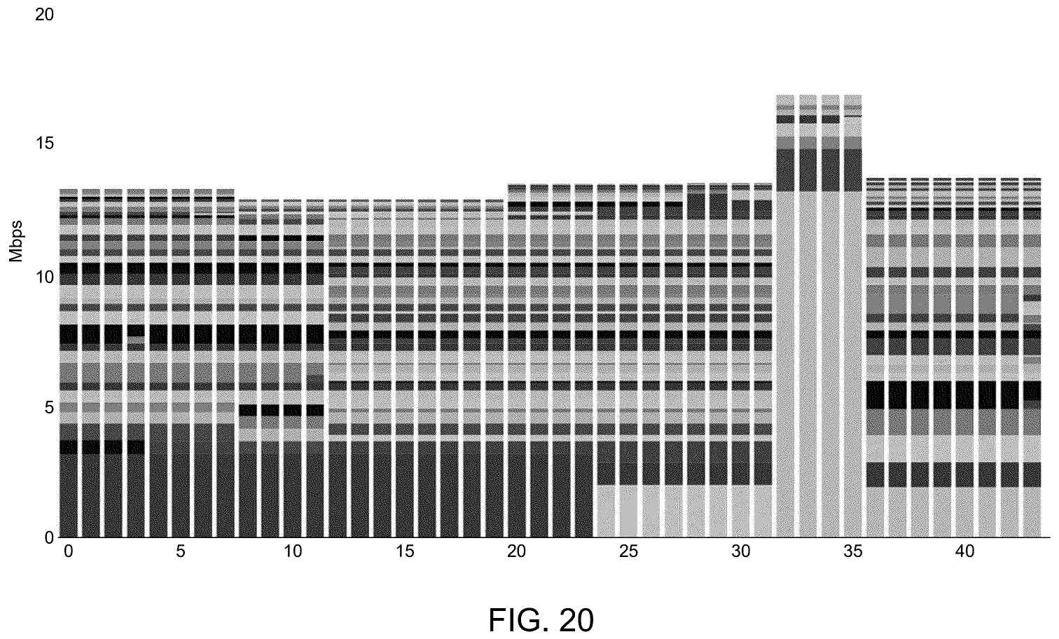

In the “before” and “after” plots, each device's aggregated usage may be water-filled to their bonded downstream SC-QAM channels, this emulates the effect the downstream scheduler can produce. In the experiments, the usage aggregation method may be the 80th percentile in each CM's over-time usage samples, and the samples within time windows, where the mean utilization of all downstream SC-QAM channels is greater than or equal to 30%, are selected. This aggregated value uses megabits per second (Mbps) as its unit as shown in the plot's y-axis in FIG. 20. The plot's x-axis may represent the downstream SC-QAM channel IDs starting from 0. Each color in the plot may represent the usage from an individual device with the “water-filling” effect.

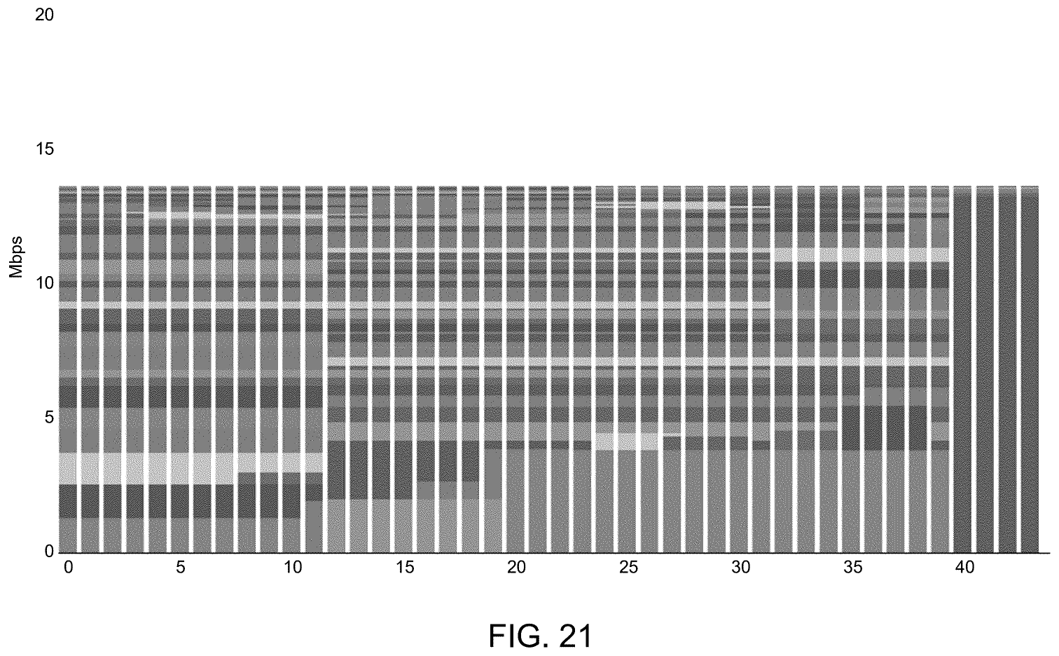

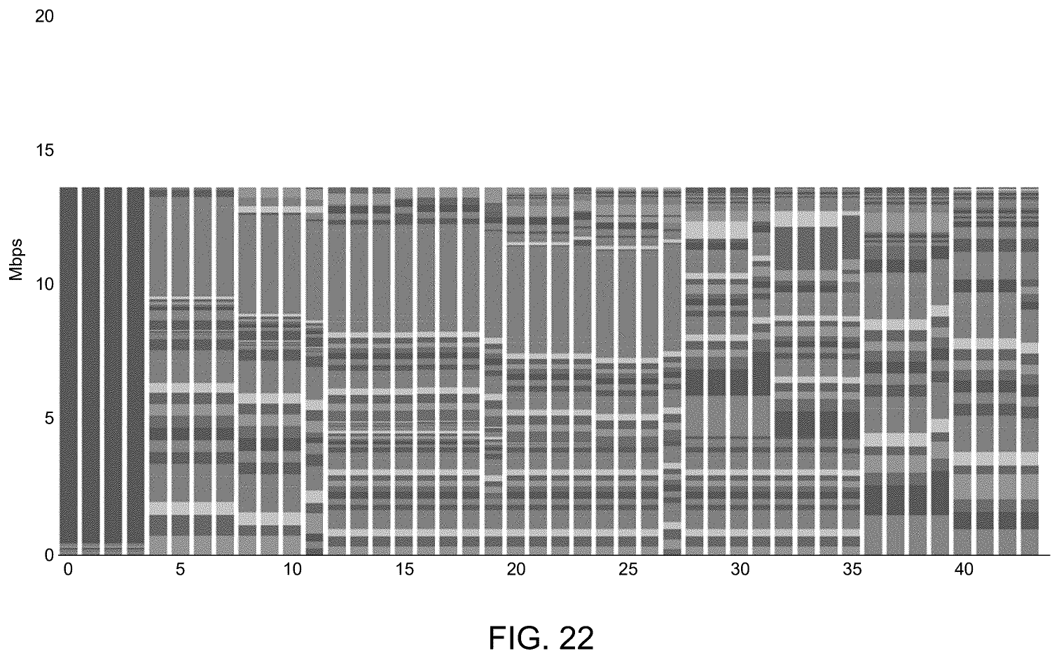

In the “before” snapshot of the service group 1 shown in FIG. 20, several high-activity users are identified, and the overall utilization is not uniformly distributed. This may be an example limitation of the static load balancer where it does not take user demand variations into account. For service group 1, the channel set 32-35 may be detected as the top channel set, and a primary contributor of the imbalance may be a highly active DOCSIS 3.0 4×4 CM. After optimization, both of the load balancing algorithm 1 and 2 projects uniformly distributed usage across all 44 downstream SC-QAM channels as shown in FIG. 21 and FIG. 22. As for the KPI, the fairness value significantly increased after the optimization. Note that after moving the CMs, their colors do not necessarily stay the same. In the analysis for this experiment, the CM media access control (MAC) addresses are used for device identification.

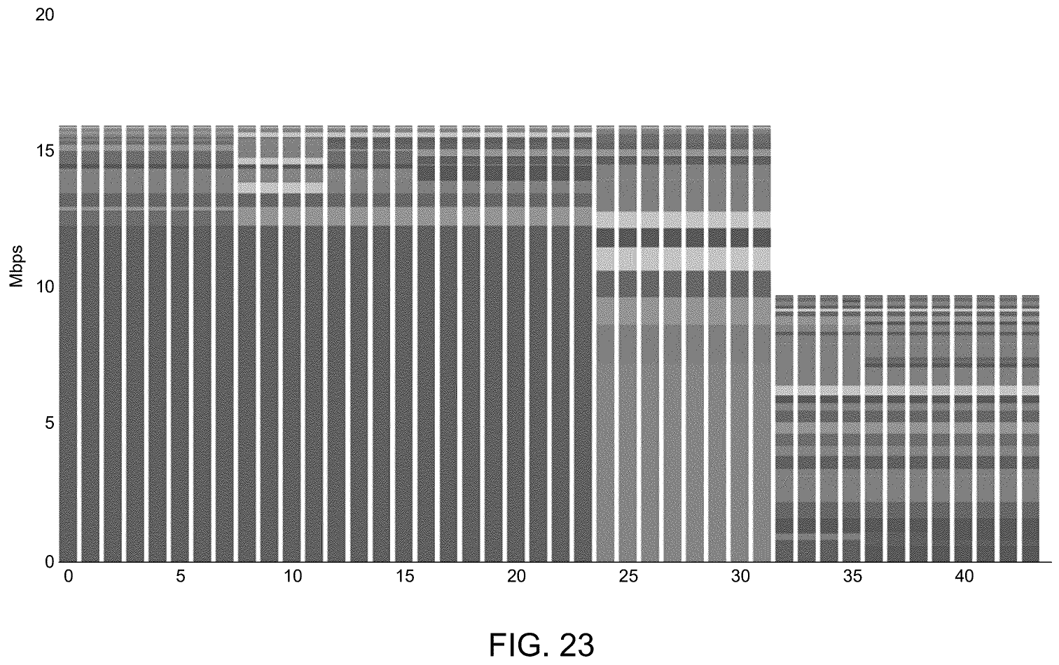

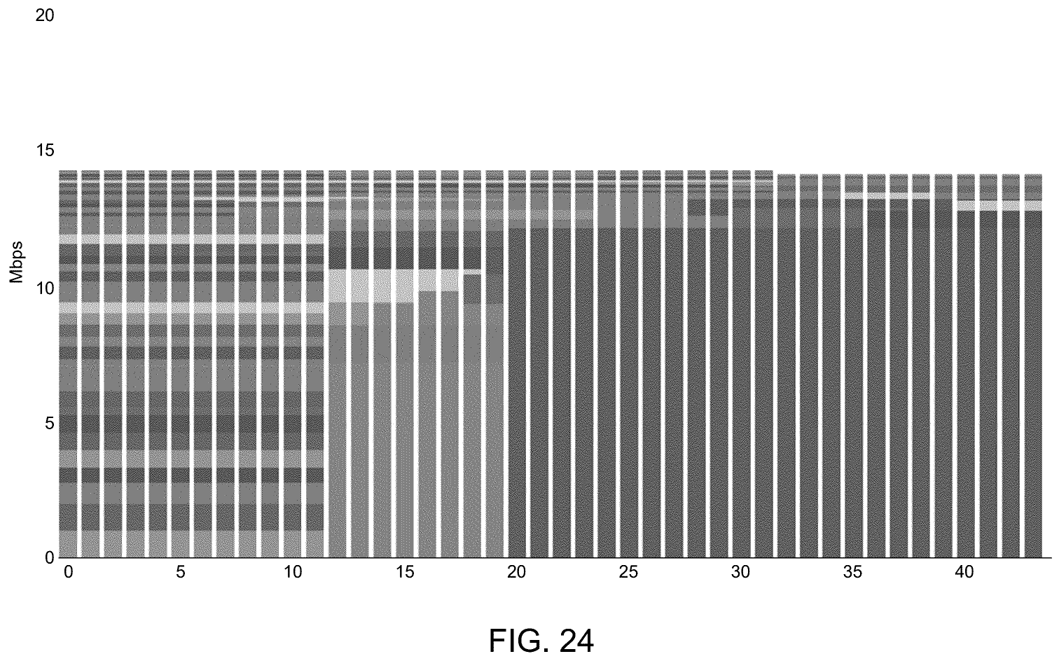

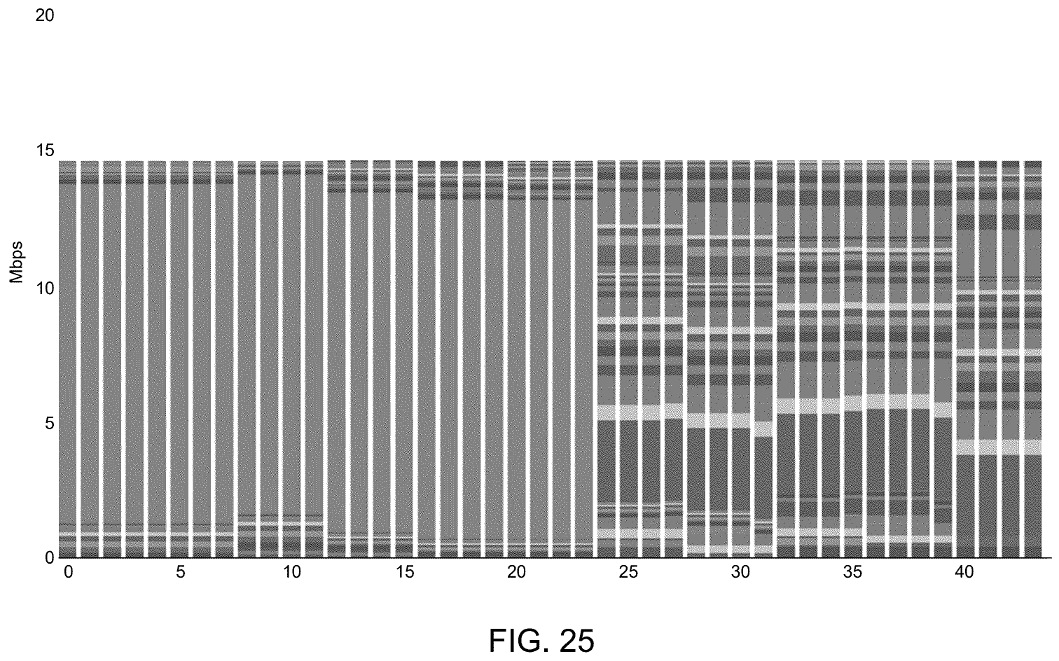

In the “before” snapshot of the service group 1 shown in FIG. 23, the channel set 0-31 may be detected as the top contributor to the imbalance, and there are several highly utilized devices. The load balancing may be significantly improved after applying either algorithm 1 or 2, as shown in FIG. 24 and FIG. 25 respectively.

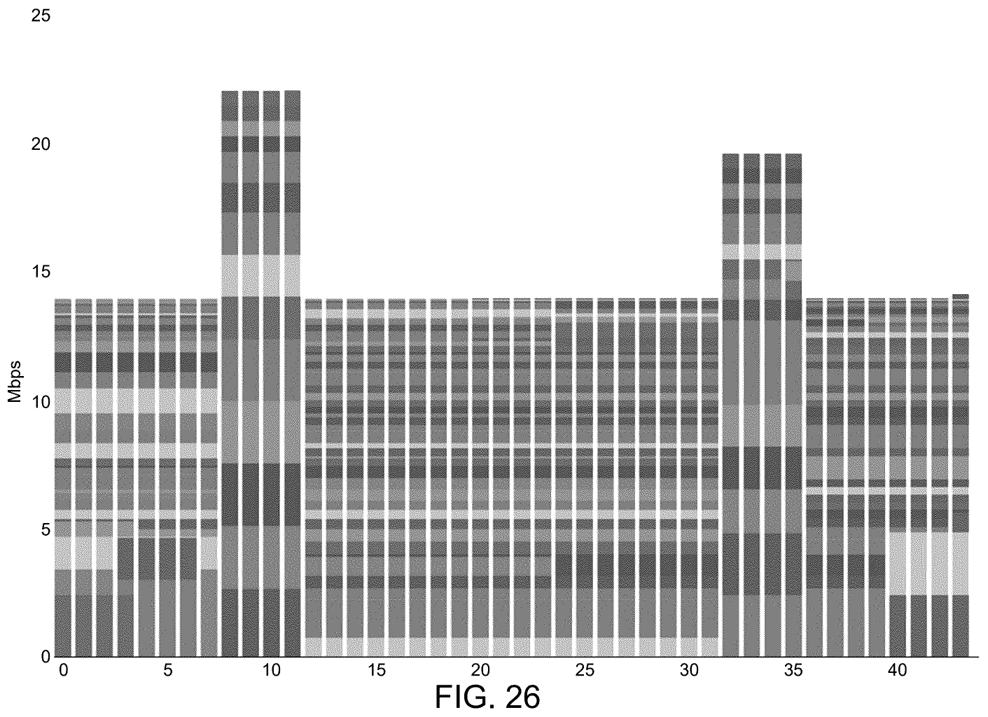

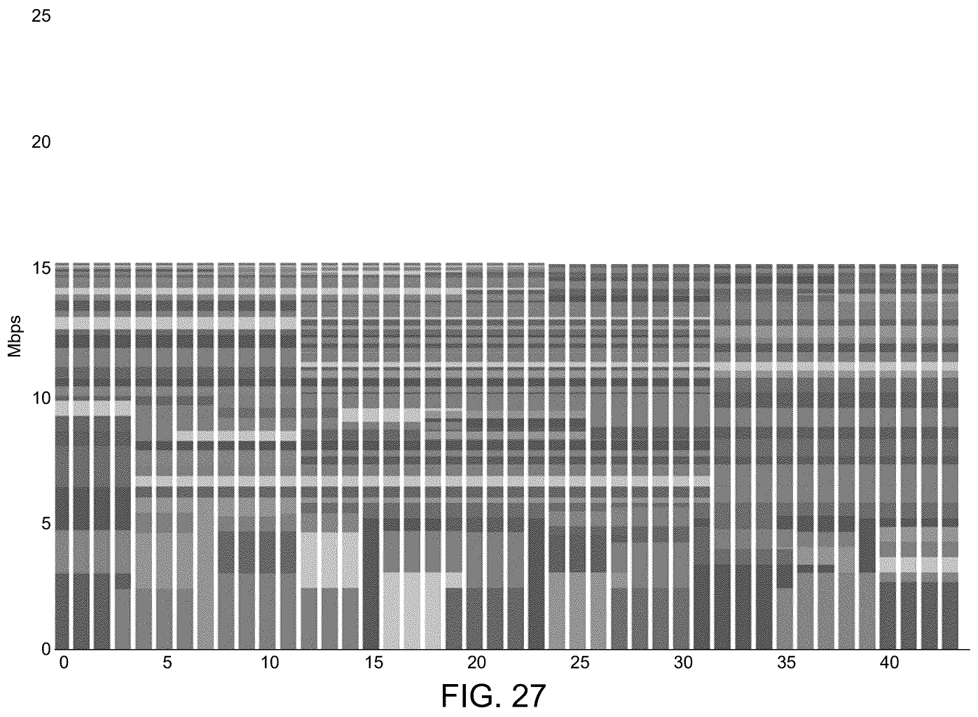

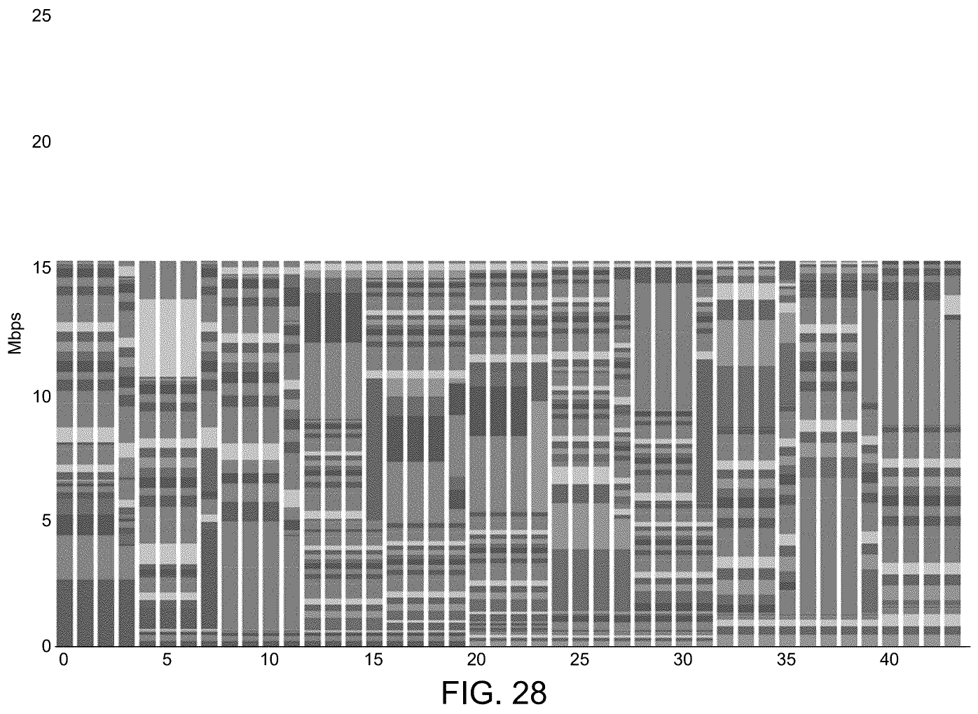

The service group 3 may start with 2 highly utilized 4-channel bonding groups on both ends of the SC-QAM spectrum as shown in FIG. 26. This situation may be improved by both of the load balancing algorithms as shown in FIG. 27 and FIG. 28.

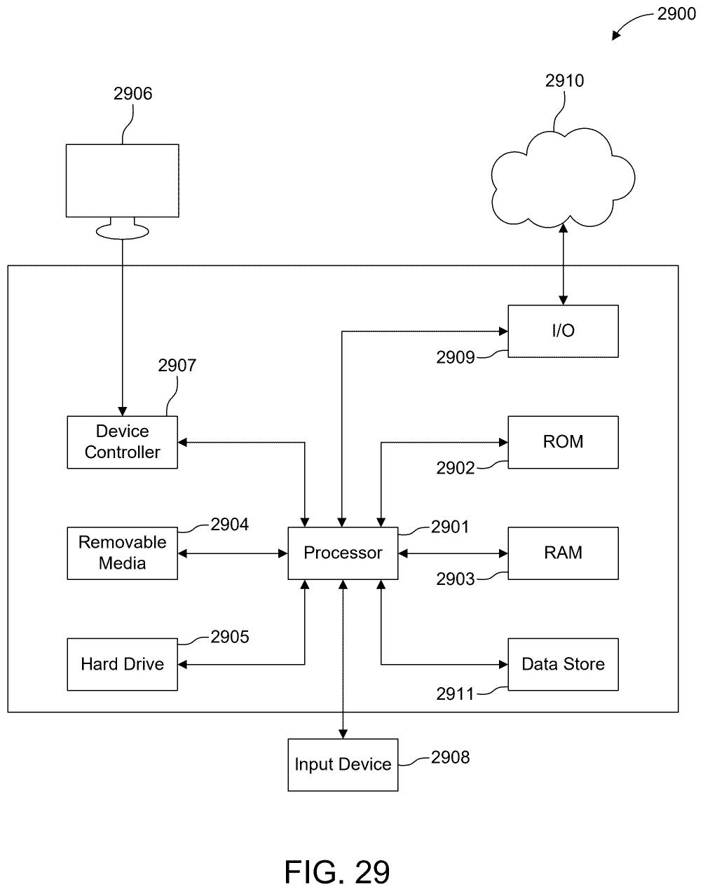

FIG. 29 shows general hardware elements that may be used to implement any of the various systems or computing devices discussed herein. For example, a CM as shown in FIG. 1 may be an example of a computing device 2900. As another example, a server housing an external load balancer 110 may be an example of a computing device 2900. The computing device 2900 may include one or more processors 2901, which may execute instructions of a computer program to perform any of the features described herein. The instructions may be stored in any type of computer-readable medium or memory, to configure the operation of the processor 2901. For example, instructions may be stored in a read-only memory (ROM) 2902, random access memory (RAM) 2903, removable media 2904, such as a Universal Serial Bus (USB) drive, compact disk (CD) or digital versatile disk (DVD), floppy disk drive, or any other desired storage medium. Instructions may also be stored in an attached (or internal) hard drive 2905. The computing device 2900 may include one or more output devices, such as a display 2906 (e.g., an external display), and may include one or more output device controllers 2907, such as a video processor. There may also be one or more user input devices 2908, such as a remote control, keyboard, mouse, touch screen, microphone, camera input for user gestures, etc. The computing device 2900 may also include one or more network interfaces, such as a network input/output (I/O) circuit 2909 (e.g., a network card) to communicate with an external network 2910. The network input/output circuit 2909 may be a wired interface, wireless interface, or a combination of the two. In some examples, the network input/output circuit 2909 may include a modem (e.g., a cable modem), and the external network 2910 may include communication links, the external network 2909, an in-home network, a provider's wireless, coaxial, fiber, or hybrid fiber/coaxial distribution system (e.g., a DOCSIS network), or any other desired network. Additionally, in some examples the device may be configured to implement one or more aspects discussed herein. For example, the device may include a data store 2911, which may be configured to receive, store, and send information regarding load balancing data or measurements taken at the device and/or in the network, and associated context. The data store 2911 may utilize other components of the device, such as hard drive 2905, removable media 2904, and/or RAM 2903.

The FIG. 29 example is a hardware configuration, although the shown components may be wholly or partially implemented as software as well. Modifications may be made to add, remove, combine, divide, etc. components of the computing device 2900 as desired. Additionally, the components shown may be implemented using basic computing devices and components, and the same components (e.g., processor 2901, ROM storage 2902, display 2906, etc.) may be used to implement any of the other computing devices and components described herein. For example, the various components herein may be implemented using computing devices having components such as a processor executing computer-executable instructions stored on a computer-readable medium, as shown in FIG. 29. Some or all of the entities described herein may be software based, and may co-exist in a common physical platform.

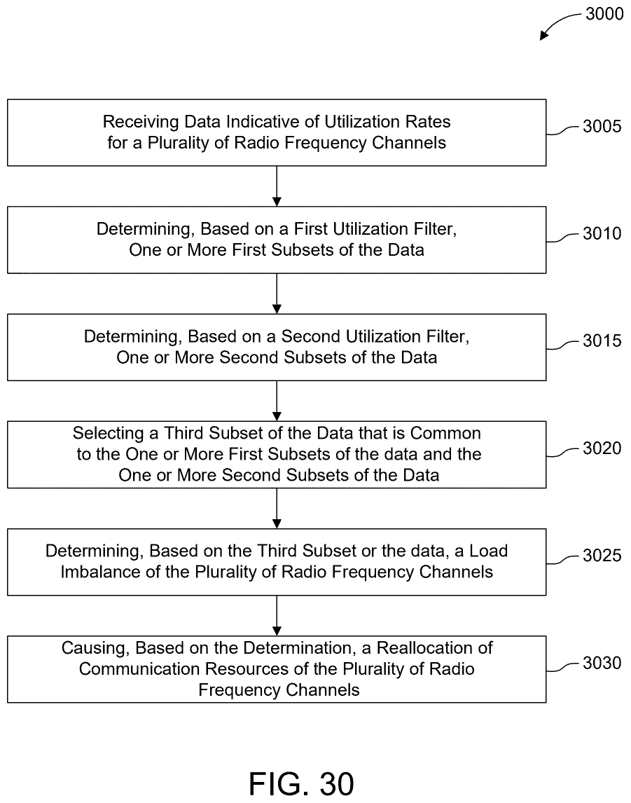

FIG. 30 shows an example method 3000 as discussed herein. The method of FIG. 30 may be implemented in one or more computing devices, such as computing device 2900 of FIG. 29. In some cases, the method of FIG. 30 may be implemented by a processor of the one or more computing devices, and executable instructions according to the method may be stored on a memory of the one or more computing devices. The one or more computing devices may be part of a system, such as system 100 of FIG. 1.

At Step 3005, data indicative of utilization rates of a plurality of radio frequency channels may be received. The utilization rates may correspond to a plurality of CMs. For example, the plurality of CMs may correspond to a service group. The utilization rates may correspond to an amount of radio frequency resources used by each of the plurality of CMs compared to a total amount of radio frequency resources for the plurality of radio frequency channels.

At Step 3010, one or more first subsets of data may be determined. The determining may be based on a first utilization filter. The first utilization filter may include a calculating of a maximum or mean utilization rate for the data across a time period. The first utilization filter may include a predefined threshold for a maximum or mean utilization rate for the data (e.g., above 90%). The one or more first subsets of data may correspond to one or more first time windows of the received data.

At Step 3015, one or more second subsets of data may be determined. The determining may be based on a second utilization filter. The second utilization filter may include a calculating of a fairness index of the data across a period of time. The fairness index may be a Jain's fairness index. The second utilization filter may include a predefined threshold for a fairness index of the data (e.g., above 35%). The one or more second subsets of data may correspond to one or more second time windows of the received data.

At Step 3020, a third subset of the data may be selected. The third subset of data may be common to the one or more first subsets of the data and the one or more second subsets of the data. The third subset of data may be determined based on an overlap of one or more first time windows with one or more second time windows.

At Step 3025, a load imbalance of the plurality of radio frequency channels may be determined. The determining may be based on the third subset of the data.

At Step 3030, communication resources of the plurality of radio frequency channels may be caused to be reallocated. The reallocating may be based on the determining.

Components are described herein that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as determined data signals (e.g., as part of a carrier wave or other analog or digital propagated signal) on a variety of computer- readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present embodiments may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method, comprising:
receiving data indicative of utilization rates for a plurality of radio frequency channels;
determining, based on a first utilization filter, one or more first subsets of the data;
determining, based on a second utilization filter, one or more second subsets of the data;
selecting a third subset of the data that is common to the one or more first subsets of the data and the one or more second subsets of the data;
determining, based on the third subset of the data, a load imbalance of the plurality of radio frequency channels; and
causing, based on the determined load imbalance, a reallocation of communication resources of the plurality of radio frequency channels.

2. The method of claim 1, wherein the first utilization filter comprises a predefined threshold of a mean or maximum utilization rate across the plurality of radio frequency channels.

3. The method of claim 1, wherein the second utilization filter comprises a predefined threshold of a fairness index across the plurality of radio frequency channels.

4. The method of claim 3, wherein the fairness index comprises a Jain's index.

5. The method of claim 1, wherein the plurality of radio frequency channels correspond to a plurality of cable modems (CMs).

6. The method of claim 5, wherein the plurality of CMs comprise a service group.

7. The method of claim 1, wherein the received data is indicative of the utilization rates across a period of time.

8. The method of claim 7, wherein the period of time comprises at least one day.

9. An apparatus, comprising:
one or more processors;
memory; and
a set of computer-executable instructions stored in the memory that, when executed by the one or more processors, cause:
receiving data indicative of utilization rates for a plurality of radio frequency channels;
determining, based on a first utilization filter, one or more first subsets of the data;
determining, based on a second utilization filter, one or more second subsets of the data;
selecting a third subset of the data that is common to the one or more first subsets of the data and the one or more second subsets of the data;
determining, based on the third subset of the data, a load imbalance of the plurality of radio frequency channels; and
causing, based on the determined load imbalance, a reallocation of communication resources of the plurality of radio frequency channels.

10. The apparatus of claim 9, wherein the first utilization filter comprises a predefined threshold of a mean or maximum utilization rate across the plurality of radio frequency channels.

11. The apparatus of claim 9, wherein the second utilization filter comprises a predefined threshold of a fairness index across the plurality of radio frequency channels.

12. The apparatus of claim 11, wherein the fairness index comprises a Jain's index.

13. The apparatus of claim 9, wherein the plurality of radio frequency channels correspond to a plurality of cable modems (CMs).

14. The apparatus of claim 13, wherein the plurality of CMs comprise a service group.

15. The apparatus of claim 9, wherein the received data is indicative of the utilization rates across a period of time.

16. A non-transitory computer-readable medium comprising a set of computer-executable instructions that, when executed by one or more processors, cause:
receiving data indicative of utilization rates for a plurality of radio frequency channels;
determining, based on a first utilization filter, one or more first subsets of the data;
determining, based on a second utilization filter, one or more second subsets of the data;
selecting a third subset of the data that is common to the one or more first subsets of the data and the one or more second subsets of the data;
determining, based on the third subset of the data, a load imbalance of the plurality of radio frequency channels; and
causing, based on the determined load imbalance, a reallocation of communication resources of the plurality of radio frequency channels.

17. The non-transitory computer-readable medium of claim 16, wherein the first utilization filter comprises a predefined threshold of a mean or maximum utilization rate across the plurality of radio frequency channels.

18. The non-transitory computer-readable medium of claim 16, wherein the second utilization filter comprises a predefined threshold of a fairness index across the plurality of radio frequency channels.

19. The non-transitory computer-readable medium of claim 18, wherein the fairness index comprises a Jain's index.

20. The non-transitory computer-readable medium of claim 16, wherein the plurality of radio frequency channels correspond to a plurality of cable modems (CMs).
